(19) United States
(12) Patent Application Publication
(10) Pub. No.: US 2018/0299279 A1
(43) Pub. Date: Oct. 18, 2018

(54) ROUTING A VEHICLE TO AVOID EMERGENCY VEHICLES

(71) Applicant: International Business Machines Corporation, Armonk, NY (US)

(72) Inventors: Dean T. Brown, San Francisco, CA (US); Hernan A. Cunico, Holly Springs, NC (US); Martin G. Keen, Cary, NC (US); David W. Messina, Malden on Hudson, NY (US)

(21) Appl. No.: 15/486,728

(22) Filed: Apr. 13, 2017

(51) Int. Cl. G01C 21/34; G08G 1/0965

(52) U.S. Cl. CPC G01C 21/3461; G01C 21/3415; G08G 1/0965

(57) ABSTRACT

A method, system and computer program product for routing a vehicle are disclosed. In an embodiment, the method comprises aggregating specified data about a first vehicle, using the aggregated data to determine a predicted route for the first vehicle, receiving data about a emergency vehicle, using the received data about the emergency vehicle to identity a route for the emergency vehicle, and determining whether there are one or more intersecting areas and times between the predicted route for the first vehicle and the identified route for the emergency vehicle. When there is an intersecting area and time between the predicted route for the first vehicle and the identified route for the emergency vehicle, an alternate route is determined for the first vehicle, an alert is sent to a driver of the first vehicle, and instructions are transmitted to that driver for avoiding the intersecting area and time.

### BACKGROUND

This invention generally relates to routing vehicles, and more specifically, to routing vehicles to avoid emergency vehicles. Embodiments of the invention calculate potential intersection points between a vehicle and an emergency vehicle en-route, and propose alternate routing based on vehicle prioritization with focus on emergency vehicles.

It is critically important that as emergency vehicles, such as ambulances and police and fire vehicles, are en-route to an emergency situation, other vehicles and traffic avoid the emergency vehicles. These other vehicles can interfere with or delay the response of the emergency vehicles to the emergency, and also can present a risk of dangerous and life-threatening accidents with the emergency vehicles.

When an emergency vehicle approaches another car, commonly the driver of that other car pulls or drives his or her car to the side or shoulder of the road and lets the emergency vehicle pass by. Pulling a vehicle over is more difficult for a driver if the vehicle is not moving, is stopped at a traffic light, or is just stuck in very slow traffic. In addition, often there is very little time for a driver to react from the moment he or she hears the sirens and sees the flashing lights of an emergency vehicle, and determines that an emergency vehicle is actually approaching and he or she needs to move.

The emergency vehicle driver needs to navigate through traffic, paying attention at other potentially distracted drivers, every other car in front of his path, and at intersections, to look for incoming traffic from the sides.

### SUMMARY

Embodiments of the invention provide a method, system and computer program product for routing a vehicle. In an embodiment, the method comprises aggregating specified data about a first vehicle, using said aggregated data to determine a predicted route for the first vehicle, receiving data about a defined emergency vehicle, using the received data about the emergency vehicle to identity a route for the emergency vehicle, and determining whether there are one or more intersecting areas and times between the predicted route for the first vehicle and the identified route for the emergency vehicle. When there is an intersecting area and time between the predicted route for the first vehicle and the identified route for the emergency vehicle, an alternate route is determined for the first vehicle, an alert is sent to a driver of the first vehicle, and instructions are transmitted to that driver for avoiding the intersecting area and time.

Embodiments of the invention are very well suited for calculating potential intersecting points between a vehicle and an emergency vehicle en-route, and proposing alternate routing based on vehicle prioritization with focus on emergency vehicles.

As mentioned above, it is critically important emergency vehicles, such as ambulances and police and fire vehicles, which are en-route to an emergency situation, other vehicles and traffic avoid the emergency vehicles. Among other difficult challenges, the emergency vehicle driver needs to navigate through traffic, paying attention to other potentially distracted drivers, every other car in front of his path, and at intersections, to look for incoming traffic from the sides.

Existing navigation assistance solutions focus on notifying drivers once an event has already occurred. For example some navigation systems may alert a driver of a car crash in front of the driver, or that there is a traffic jam, or provide information about general driving conditions, etc. However, there is no system in place today which can alert a driver of oncoming emergency vehicles before the driver begins to hear sirens or see flashing lights of an emergency vehicle.

Therefore, there is a need for a system that alerts drives to incoming emergency vehicles well in advance of the time the driver sees or hears the emergency vehicle in order to provide a clear path for such emergency vehicle and to maximize the travelling speed of the emergency vehicle and to minimize the risks of unnecessary delays to an accident scene with the emergency vehicle.

Embodiments of the invention analyze individual vehicle routes (planned and/or learned/predicted), calculate intersection points with emergency vehicles, and re-route vehicles to clear the path of the emergency vehicle.

Embodiments of the invention provide the following features:

Use routing information and/or predictive analytics to determine where vehicle A is and where it is going;
Use a combination of global positioning satellite (GPS) data and a navigation system on the emergency vehicle B to determine its current location and destination;
Use the above information to predict an intersection of both paths;
When multiple emergency vehicles approach from different routes, use algorithms to prioritize and clear their paths;
Vehicle to vehicle communication may be used to efficiently distribute the vehicles;
Alert the car driver to an incoming emergency vehicle long before the emergency vehicle can be seen by the car driver; and
Propose alternate routes to the car driver in order to clear the best path for the emergency vehicle.

### BRIEF DESCRIPTION OF THE SEVERAL VIEWS OF THE DRAWINGS

FIG. 1 is an overview of an architecture for a system embodying this invention.

FIG. 2 shows a road map with several emergency vehicles and a non-emergency vehicle.

FIG. 3 depicts a pictorial representation of a network environment that may be used in embodiments of the invention.

FIG. 4 illustrates a diagram of a data processing system that may be used in the network environment of FIG. 3.

### DETAILED DESCRIPTION

This invention generally relates to routing vehicles, and more specifically, to routing vehicles to avoid emergency vehicles. In an embodiment, the invention comprises aggregating specified data about a first vehicle, using said aggregated data to determine a predicted route for the first vehicle, receiving data about a defined emergency vehicle, using the received data about the emergency vehicle to identity a route for the emergency vehicle, and determining whether there are one or more intersecting areas and times between the predicted route for the first vehicle and the identified route for the emergency vehicle. When there is an intersecting area and time between the predicted route for the first vehicle and the identified route for the emergency vehicle, an alternate route is determined for the first vehicle, an alert is sent to a driver of the first vehicle, and instructions are transmitted to that driver for avoiding the intersecting area and time.

Embodiments of the invention aggregate individual driving patterns (both learned/predictable and planned) and calculate intersection points of such patterns. To achieve this, in embodiments of the invention, the system relies on a series of distributed components and vehicle-to-vehicle communication.

The navigation system uses historical data and current traffic conditions to predict where a vehicle might be going and what route the vehicle might be taking. Once the system calculates potential destinations and routes, then it calculates the intersection points with the emergency vehicles along those routes. These intersections are time sensitive. With all this information, the system finally proposes an alternate route.

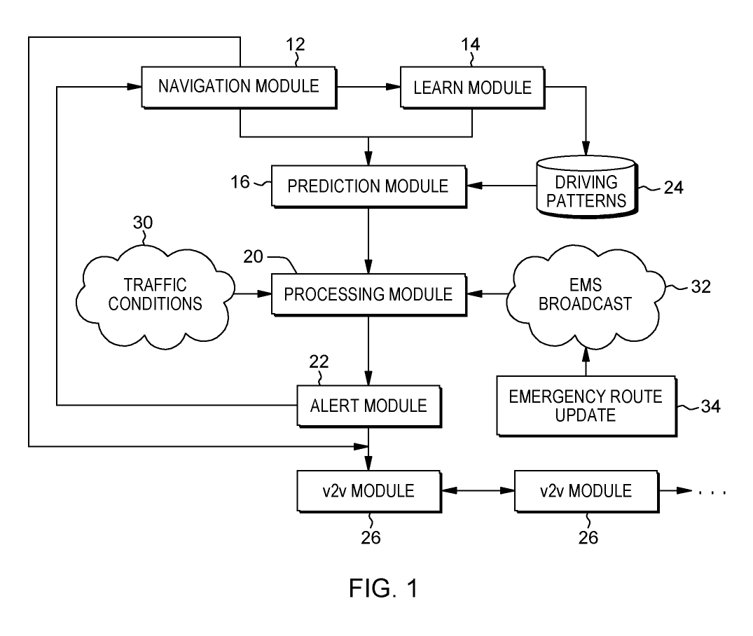

FIG. 1 illustrates an overview of an architecture for a system embodying this invention. Generally, this architecture comprises a group of modules including navigation module 12, learning module 14, prediction module 16, processing module 20, and alert module 22. The architecture of FIG. 1 also comprises a database 24 of driving patterns, and a plurality of vehicle-to-vehicle communication modules 26. As represented at 30, the architecture receives input about traffic conditions; and as represented at 32, input is received about emergency medical services (EMS) broadcasts. The EMS broadcasts, in turn, may receive emergency route updates 34.

Embodiments of the invention may be used in a wide range of specific situations involving a range of numbers of emergency and non-emergency vehicles. Two examples of embodiments of the invention are discussed in detail below. In the first example, a single user non-emergency vehicle is routed to avoid one or more emergency vehicles, and in the second example, multiple non-emergency vehicles are re-routed.

### Single Use Scenario

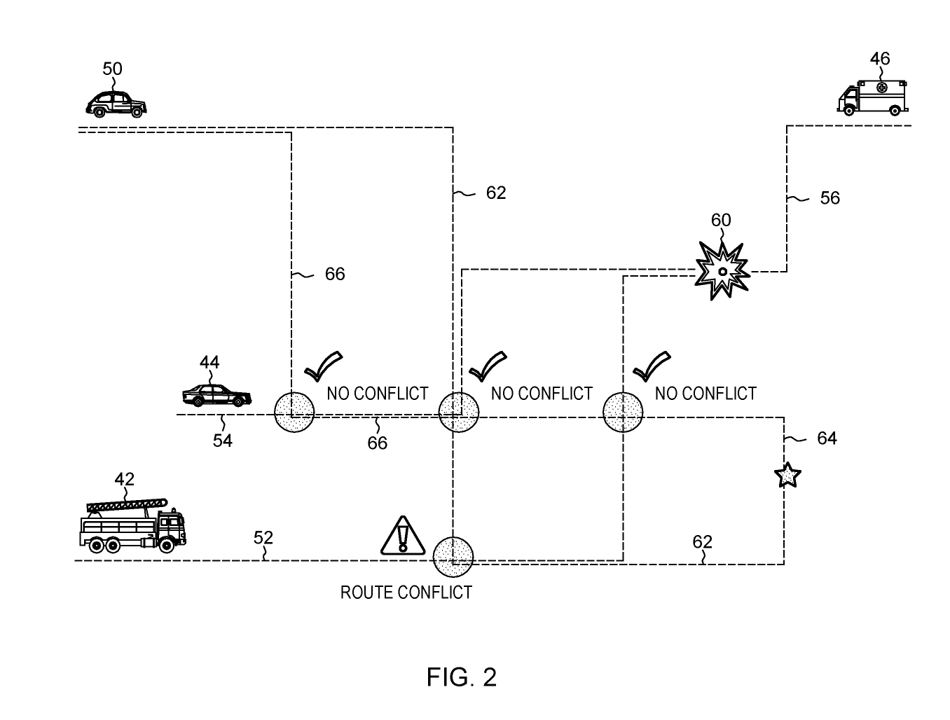

FIG. 2 shows a road map with several emergency vehicles 42, 44, 46 and a non-emergency vehicle 50. With reference to FIGS. 1 and 2, in embodiments of the invention, in a single user scenario, the Learning Module 14 analyzes and learns a user's driving habits. This module is user specific, vehicle independent and feeds data into the Prediction Module 16. The Navigation Module 12 is used to plot routes and feeds data into the learning and prediction modules 14 and 16. The Prediction Module 16 takes data from the learning and navigation modules and is able to predict driving patterns. For example, Prediction Module 16 predicts where the vehicle 50 is likely to be at any given time, possible destinations, usual routes, traveling speed, who is onboard, and other features.

EMS broadcasts emergency vehicle type and route. A broadcast is likely to include multiple emergency vehicles from different origins traveling to a common destination. This broadcast information is available for the duration of the emergency. Emergency vehicles 42, 44, 46 transmit actual route information back to EMS to keep the broadcast current. The Processing Module 20 receives EMS traffic broadcast data and extrapolates this data over the possible routes for the current user provided by the Prediction Module 16. The Processing Module analyzes current traffic conditions, calculates intersection points and times of such intersections, calculates a buffer time to avoid intersection area, identifies such an intersection area as a “temporary area to avoid”, sends information identifying this temporary area to avoid back to the navigation system 12, and activates Alert Module 22.

The Alert Module 22 announces to the driver that there is an emergency in progress in the vicinity and to follow instructions from the Navigation Module 12. The Navigation Module 12 calculates and displays a new route to bypass the identified “temporary area to avoid”. This new route can be more than just an alternate route or path. The new route can include maintaining the current course but decrease speed, make a safe, temporary stop, or take the alternate (proposed) route. The new route calculation is prioritized by taking into account a number of factors such as the number of emergency vehicles, current traffic information, proximity to those emergency vehicles, proximity of the user's vehicle to the emergency destination, and other user vehicles in the area.

### Multiple Users Scenario

In a more common scenario, there will be multiple users' cars in the paths of emergency vehicles. Embodiments of the invention handle this situation with vehicle-to-vehicle communication. The v2v Module 26 broadcasts an alternate route to other user vehicles in the vicinity and potentially in the paths of the emergency vehicles and/or the current user vehicle. The Processing Module 20 receives EMS traffic data, predicted user paths, and in this embodiment, the processing module also accounts for v2v Module data to calculate the new route. The Processing Module adds to the prioritization process which user vehicle calculated and communicated first their change of route. This way, prioritization of routes is done in an outwards, radial way.

For simplicity, only one user car 50 is illustrated in FIG. 2.

In this scenario, the user would not be able to see or hear the emergency vehicles until the emergency vehicle is in a direct line of sight of the user. In FIG. 2, dotted lines 52, 54, 56 represents emergency vehicle routes to an emergency at 60, dotted line 62 represents the original route for vehicle 50 predicted (or planned) by the system to a destination 64, and dotted line 66 represents a new, alternate route for vehicle 50.

In this scenario, a user is driving to a usual destination, an emergency occurs and EMS broadcasts details about the emergency vehicles being dispatched. The system receives the EMS broadcast and determines that based on current user route prediction, there will be a conflict with one of the emergency vehicles. The system calculates a new alternate route, calculating location and timing of when such routes could intersect. The user gets notified and changes the route long before ever seeing or hearing any emergency vehicle.

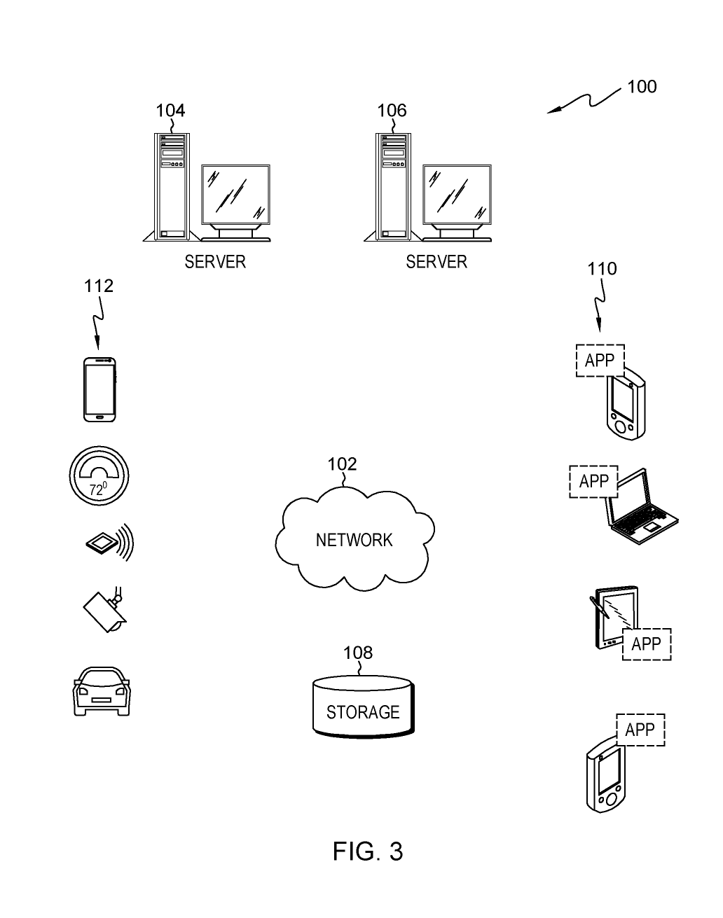

FIG. 3 is a diagram illustrating an exemplary network environment 100 that may be used in or with embodiments of the invention. Network environment 100 includes network 102, servers 104, 106, storage unit 108, user or client devices 110, and other processing devices 112. The other processing devices may be on or in the user vehicle 50 or the emergency vehicles 42, 44, 46 and used to provide information about those vehicles or the drivers of those vehicles, and these other devices may include devices of the type referred to as Internet of Things (IoT) devices. Network 102 is the medium used to provide communication links between various devices and computers within network environment 100. Components of network environment 100 may be connected via wired and/or wireless links. The network environment may include additional servers, clients, and other devices not shown.

In the depicted example, server 104 and server 106 connect to network 102 along with storage unit 108. Server 104 provides information, such as boot files, operating system images, and applications to clients 110.

User devices 110 may include computational or communication device. In embodiments of the invention, the user devices may provide information about the non-emergency vehicle or the emergency vehicles or about the drivers of those vehicles. In addition, in embodiments of the invention, user devices 110 may enable a user to control or otherwise communicate with one or more of the devices 112. For example, user devices 110 may include a personal computer (e.g., a laptop or desktop PC), a tablet computer, a smart phone, or another type of computational or communication device that can communicate with devices in network environment 100. In one implementation, user devices 110 may include one or more applications that provide functionality or services to the users.

User devices 110 may include mobile devices. Mobile devices may each include any type of electronic device that includes a first wireless transceiver capable of communicating via the short range wireless protocol, and a second wireless transceiver capable of communicating wireless via network 102 (e.g., via IEEE 802.11 standard). Mobile devices may include, for example, a cellular telephone (e.g., a smart phone), a personal digital assistant (PDA); a palmtop, laptop, or tablet computer; a media playing device; a game playing device, or a digital camera device. Mobile devices may each store and execute one or more applications.

Devices 112 may include a variety of devices that can communicate with other devices in network environment 100. Devices 112 may, in embodiments of the invention, be on or in vehicles 42, 44, 46, 50 and used to provide information about the user vehicle or the emergency vehicles, about the drivers of those vehicles, or about the environments in which these vehicles are located or travelling to. Devices 112 may include Internet of Things (IoT) devices. Examples of IoT devices include a location tag, a monitoring camera, a sensor device, or anything that has an Internet connection. In one implementation, devices 112 may connect to the Internet to report data or request information. Devices 112 may also listen to and be paged from other devices via network 102. IoT devices, for instance, typically have one or more specific functions to perform, such as measuring, monitoring, and/or reporting data. IoT devices may connect to network 102 in different ways, such as via a fixed Wi-Fi connection, a Bluetooth connection, a direct wireless network connection. While several specific devices 112 are shown in FIG. 3, embodiments of the invention may use more, or fewer, devices than are expressly shown in the Fig.

IoT devices may each include a physical object or device that further includes a processing unit, one or more sensors for sensing aspects of the IoT device's environment, and a short range wireless transceiver. IoT devices generate sensor data from the one or more sensors and broadcast the sensor data, via one or more advertising PDUs, using the short range wireless protocol.

Program code located in network data processing system 100 may be stored on a computer recordable storage medium and downloaded to a data processing system or other device for use. For example, program code may be stored on a computer recordable storage medium on server 104 and downloaded to one or more of the client devices 110 over network 102 for use on the client 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Network 100 also may be implemented as a number of different types of networks, such as for example, an intranet, a local area network (LAN), or a wide area network (WAN). FIG. 3 is intended as an example, and not as an architectural limitation for the different illustrative embodiments.

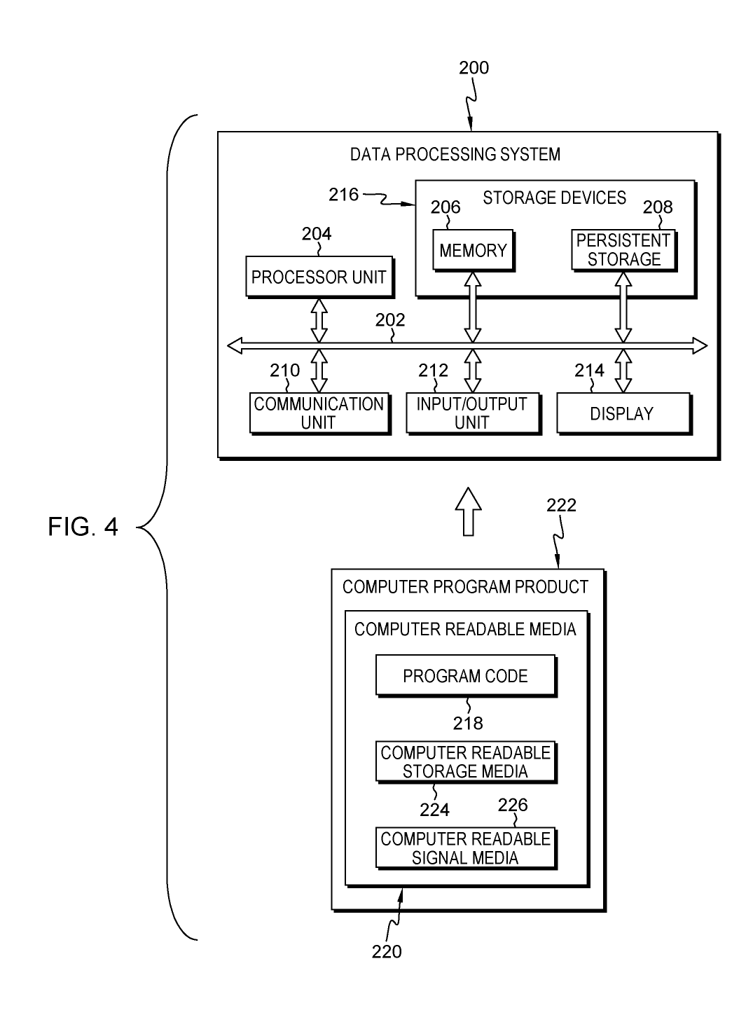

FIG. 4 depicts a diagram of a data processing system in accordance with an illustrative embodiment. Data processing system 200 is an example of a computer, such as server 104 or a personal computer that may be used in the network of FIG. 3, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems, in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example, without limitation, data, program code in functional form, and/or other suitable information either on a temporary basis and/or a permanent basis. Memory 206, in these examples, may be, for example, a random access memory, or any other suitable volatile or non-volatile storage device. Persistent storage 208 may take various forms, depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 may be removable. For example, a removable hard drive may be used for persistent storage 208.

Communications unit 210, in these examples, provides for communication with other data processing systems or devices. In these examples, communications unit 210 is a network interface card. Communications unit 210 may provide communications through the use of either or both physical and wireless communications links.

Input/output unit 212 allows for the input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications, and/or programs may be located in storage devices 216, which are in communication with processor unit 204 through communications fabric 202. In these illustrative examples, the instructions are in a functional form on persistent storage 208. These instructions may be loaded into memory 206 for execution by processor unit 204. The processes of the different embodiments may be performed by processor unit 204 using computer implemented instructions, which may be located in a memory, such as memory 206.

These instructions are referred to as program code, computer usable program code, or computer readable program code that may be read and executed by a processor in processor unit 204. The program code, in the different embodiments, may be embodied on different physical or computer readable storage media, such as memory 206 or persistent storage 208.

Program code 218 is located in a functional form on computer readable media 220 that is selectively removable and may be loaded onto or transferred to data processing system 200 for execution by processor unit 204. Program code 218 and computer readable media 220 form computer program product 222. In one example, computer readable media 220 may be computer readable storage media 224 or computer readable signal media 226. Computer readable storage media 224 may include, for example, an optical or magnetic disc that is inserted or placed into a drive or other device that is part of persistent storage 208 for transfer onto a storage device, such as a hard drive, that is part of persistent storage 208. Computer readable storage media 224 also may take the form of a persistent storage, such as a hard drive, a thumb drive, or a flash memory that is connected to data processing system 200. In some instances, computer readable storage media 224 may not be removable from data processing system 200.

Alternatively, program code 218 may be transferred to data processing system 200 using computer readable signal media 226. Computer readable signal media 226 may be, for example, a propagated data signal containing program code 218. For example, computer readable signal media 226 may be an electro-magnetic signal, an optical signal, and/or any other suitable type of signal. These signals may be transmitted over communications links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communications links or wireless transmissions containing the program code.

In some illustrative embodiments, program code 218 may be downloaded over a network to persistent storage 208 from another device or data processing system through computer readable signal media 226 for use within data processing system 200. For instance, program code stored in a computer readable storage media in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 4 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor.

As another example, a storage device in data processing system 200 is any hardware apparatus that may store data. Memory 206, persistent storage 208, and computer readable media 220 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Those of ordinary skill in the art will appreciate that the architecture and hardware depicted in FIGS. 3 and 4 may vary.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The description of the invention has been presented for purposes of illustration and description, and is not intended to be exhaustive or to limit the invention in the form disclosed. Many modifications and variations will be apparent to those of ordinary skill in the art without departing from the scope of the invention. The embodiments were chosen and described in order to explain the principles and applications of the invention, and to enable others of ordinary skill in the art to understand the invention. The invention may be implemented in various embodiments with various modifications as are suited to a particular contemplated use.

1. A method of routing a vehicle, comprising:
aggregating specified data about a first vehicle;
using said aggregated data to determine a predicted route for the first vehicle;
receiving data about a defined emergency vehicle;
using the received data about the emergency vehicle to identity a route for the emergency vehicle;
determining whether there are one or more intersecting areas and times between the predicted route for the first vehicle and the identified route for the emergency vehicle; and
when there is an intersecting area and time between the predicted route for the first vehicle and the identified route for the emergency vehicle, determining an alternate route for the first vehicle, sending an alert to a driver of the first vehicle, and transmitting instructions to the driver for avoiding the intersecting area and time.

2. The method according to claim 1, wherein the specified data about a first vehicle includes defined driving patterns of the driver of the first vehicle.

3. The method according to claim 2, wherein the defined driving patterns include learned driving patterns of the driver of the first vehicle, said learned driving patterns being learned from a history of driving of the driver of the first vehicle.

4. The method according to claim 1, wherein the specified data about a first vehicle includes a group of destinations of the driver of the first vehicle, and a group of routes to the group of destinations.

5. The method according to claim 4, wherein the group of destinations of the driver of the first vehicle includes one or more destinations learned from a driving history of the driver of the first vehicle.

6. The method according to claim 1, wherein the specified data about a first vehicle include a current position of the first vehicle, and defined traffic conditions in a specified area.

7. The method according to claim 1, wherein the data about an emergency vehicle include data identifying a current location, a current speed, and a destination of the emergency vehicle.

8. The method according to claim 7, wherein the data about an emergency vehicle is received from the emergency vehicle.

9. The method according to claim 1, wherein:
the determining whether there are intersecting areas and times between the predicted route for the first vehicle and the identified route for the emergency vehicle includes determining a specified area to avoid for the first vehicle to avoid the emergency vehicle; and
the transmitting instructions to the driver for avoiding the intersecting areas and times includes notifying the drive of the first vehicle of the specified area to avoid.

10. The method according to claim 1, wherein:
the determining an alternate route for the first driver includes determining one or more alternate routes; and
the method further comprises the first vehicle broadcasting information identifying said one or more alternate routes to other vehicles in a specified area.

11. A system for routing a vehicle, comprising:
a computer system comprising a database for storing data including aggregated specified data about a first vehicle; and one or more processing units, including hardware, connected to the database for transmitting data to and receiving data from the data base, the one or more processing units configured to operate as:
a processing module for using said aggregated data to determine a predicted route for the first vehicle, for receiving data about a defined emergency vehicle and using the received data about the emergency vehicle to identity a route for the emergency vehicle, and for determining whether there are one or more intersecting areas and times between the predicted route for the first vehicle and the identified route for the emergency vehicle;
an alert module for sending an alert to a driver of the first vehicle when there is an intersecting area and time between the predicted route for the first vehicle and the identified route for the emergency vehicle; and
a navigation module for determining an alternate route for the first vehicle when there is an intersecting area and time between the predicted route for the first vehicle and the identified route for the emergency vehicle, and transmitting instructions to the driver for avoiding the intersecting area and time.

12. The system according to claim 11, wherein the specified data about a first vehicle includes defined driving patterns of the driver of the first vehicle.

13. The system according to claim 12, wherein the defined driving patterns include learned driving patterns of the driver of the first vehicle, and the system further comprises a learning module for learning said learned driving patterns from a history of driving of the driver of the first vehicle.

14. The system according to claim 11, wherein the specified data about a first vehicle includes a group of destinations of the driver of the first vehicle, and a group of routes to the group of destinations.

15. The system according to claim 14, further comprising a learning module for learning said the group of destinations of the driver and said group of routes from a driving history of the driver of the first vehicle.

16. A computer program product for routing a vehicle, comprising:
a computer readable storage medium having program instructions embodied therein, the program instructions executable by a computer to cause the computer to perform the method of:
using aggregated specified data about a first vehicle to determine a predicted route for the first vehicle;
receiving data about a defined emergency vehicle;
using the received data about the emergency vehicle to identity a route for the emergency vehicle;
determining whether there are one or more intersecting areas and times between the predicted route for the first vehicle and the identified route for the emergency vehicle; and
when there is an intersecting area and time between the predicted route for the first vehicle and the identified route for the emergency vehicle, determining an alternate route for the first vehicle, sending an alert to a driver of the first vehicle, and transmitting instructions to the driver for avoiding the intersecting area and time.

17. The computer program product according to claim 16, wherein the specified data about a first vehicle includes defined driving patterns of the driver of the first vehicle.

18. The computer program product according to claim 17, wherein the defined driving patterns include learned driving patterns of the driver of the first vehicle. and said method further comprises learning said driving patterns from a history of driving of the driver of the first vehicle.

19. The computer program product according to claim 16, wherein the specified data about a first vehicle includes a group of destinations of the driver of the first vehicle, and a group of routes to the group of destinations.

20. The computer program product according to claim 19, wherein the method further comprises learning the group of destinations of the driver of the first vehicle from a driving history of the driver of the first vehicle.
